(19) United States
(12) Patent Application Publication
(10) Pub. No.: US 2014/0129400 A1
(43) Pub. Date: May 8, 2014

(54) ELECTRONIC PAYMENT PROCESSING SYSTEM

(71) Applicant: Syncada LLC, Minneapolis, MN (US)

(72) Inventors: Kevin M. Armstrong, Ham Lake, MN (US); Thomas J. Crowe, Woodbury, MN (US); Dennis J. McCormick, Shakopee, MN (US); Harold Gustave Roger Bosse, Brussels (BE)

(21) Appl. No.: 14/074,676

(22) Filed: Nov. 7, 2013

Related U.S. Application Data
(60) Provisional application No. 61/723,633, filed on Nov. 7, 2012.

(51) Int. Cl. G06Q 30/04; G06Q 10/08

(52) U.S. Cl. CPC G06Q 30/04; G06Q 10/08345
USPC 705/34

(57) ABSTRACT

A computing system receives an invoice and matches, based on a country in which a carrier of the shipment is established, a country in which a recipient of the shipment is established, an origin country of the shipment, and a destination country of the shipment, the invoice to a row in a buyer-specified configuration matrix. The computing system determines, based on the identified row in the buyer-specified configuration matrix, whether a buyer or the shipper is responsible for payment of value-added tax (VAT) on the shipment. If the buyer is responsible for payment of the VAT on the shipment, the computing system includes a line item in the invoice that indicates that the buyer is responsible for payment of the VAT on the shipment. The computing system provides the invoice to the buyer.

This application claims the benefit of U.S. Provisional Patent Application No. 61/723,633, filed Nov. 7, 2012, the entire content of which is incorporated herein by reference.

### SUMMARY

In one example, this disclosure describes a method comprising: receiving, by a computing system, an invoice that specifies a country in which a carrier of a shipment is established, a country in which a recipient of the shipment is established, an origin country of the shipment, and a destination country of the shipment; matching, by the computing system and based on the country in which the carrier of the shipment is established, the country in which the recipient of the shipment is established, the origin country of the shipment, and the destination country of the shipment, the invoice to a row in a buyer-specified configuration matrix; determining, by the computing system and based on the identified row in the buyer-specified configuration matrix, whether a buyer is responsible for payment of value-added tax (VAT) on the shipment or whether the shipper is responsible for payment of the VAT on the shipment; in response to determining that the buyer is responsible for payment of the VAT on the shipment, including, by the computing system, a line item in the invoice that indicates that the buyer is responsible for payment of the VAT on the shipment; and providing, by the computing system, the invoice to the buyer.

In another example, this disclosure describes a computing device that comprises one or more processors configured to: receive an invoice that specifies a country in which a carrier of a shipment is established, a country in which a recipient of the shipment is established, an origin country of the shipment, and a destination country of the shipment; match based on the country in which the carrier of the shipment is established, the country in which the recipient of the shipment is established, the origin country of the shipment, and the destination country of the shipment, the invoice to a row in a buyer-specified configuration matrix; determine, based on the identified row in the buyer-specified configuration matrix, whether a buyer is responsible for payment of value-added tax (VAT) on the shipment or whether the shipper is responsible for payment of the VAT on the shipment; in response to determining that the buyer is responsible for payment of the VAT on the shipment, include a line item in the invoice that indicates that the buyer is responsible for payment of the VAT on the shipment; and provide the invoice to the buyer.

In another example, this disclosure describes a computer-readable storage medium that stores instructions that, when executed by one or more processors of a computing system, cause the computing system to receive an invoice that specifies a country in which a carrier of a shipment is established, a country in which a recipient of the shipment is established, an origin country of the shipment, and a destination country of the shipment; match based on the country in which the carrier of the shipment is established, the country in which the recipient of the shipment is established, the origin country of the shipment, and the destination country of the shipment, the invoice to a row in a buyer-specified configuration matrix; determine, based on the identified row in the buyer-specified configuration matrix, whether a buyer is responsible for payment of value-added tax (VAT) on the shipment or whether the shipper is responsible for payment of the VAT on the shipment; in response to determining that the buyer is responsible for payment of the VAT on the shipment, include a line item in the invoice that indicates that the buyer is responsible for payment of the VAT on the shipment; and provide the invoice to the buyer.

In another example, this disclosure describes a method comprising: receiving, by a computing system, an order from a buyer, the order specifying quantities of goods to be shipped, by a shipper and accordingly to a predefined route, from a shipper to a plurality of facilities associated with the buyer; receiving, by the computing system, a plurality of invoices; and in response to determining that the invoices include invoices to each of the facilities, initiating, by the computing system, an electronic payment for the goods.

In another example, this disclosure describes a computing device that comprises one or more processors configured to: receive an order from a buyer, the order specifying quantities of goods to be shipped, by a shipper and accordingly to a predefined route, from a shipper to a plurality of facilities associated with the buyer; receive a plurality of invoices; and in response to determining that the invoices include invoices to each of the facilities, initiate an electronic payment for the goods.

In another example, this disclosure describes a computer-readable storage medium that stores instructions that, when executed by one or more processors of a computing system, cause the computing system to: receive an order from a buyer, the order specifying quantities of goods to be shipped, by a shipper and accordingly to a predefined route, from a shipper to a plurality of facilities associated with the buyer; receive a plurality of invoices; and in response to determining that the invoices include invoices to each of the facilities, initiate an electronic payment for the goods.

### BRIEF DESCRIPTION OF THE DRAWINGS

FIG. 1 is a block diagram that illustrates an example configuration of a computing device, in accordance with the techniques of this disclosure.

FIG. 2 is a flowchart that illustrates an example operation for processing reverse-charge VAT.

FIG. 3 is a flowchart that illustrates an example operation for processing a milk run transaction.

FIG. 4 is a conceptual diagram that illustrates an example user interface showing “Non-Financial Journal-VAT” line items on an accounting tab.

FIG. 5 is a conceptual diagram that illustrates an example consolidated invoice.

FIG. 6 is a conceptual diagram that illustrates an example shipments tab on the consolidated invoice.

FIG. 7 is a conceptual diagram that illustrates example financial statuses available within a status tab of an advance search process.

### DETAILED DESCRIPTION

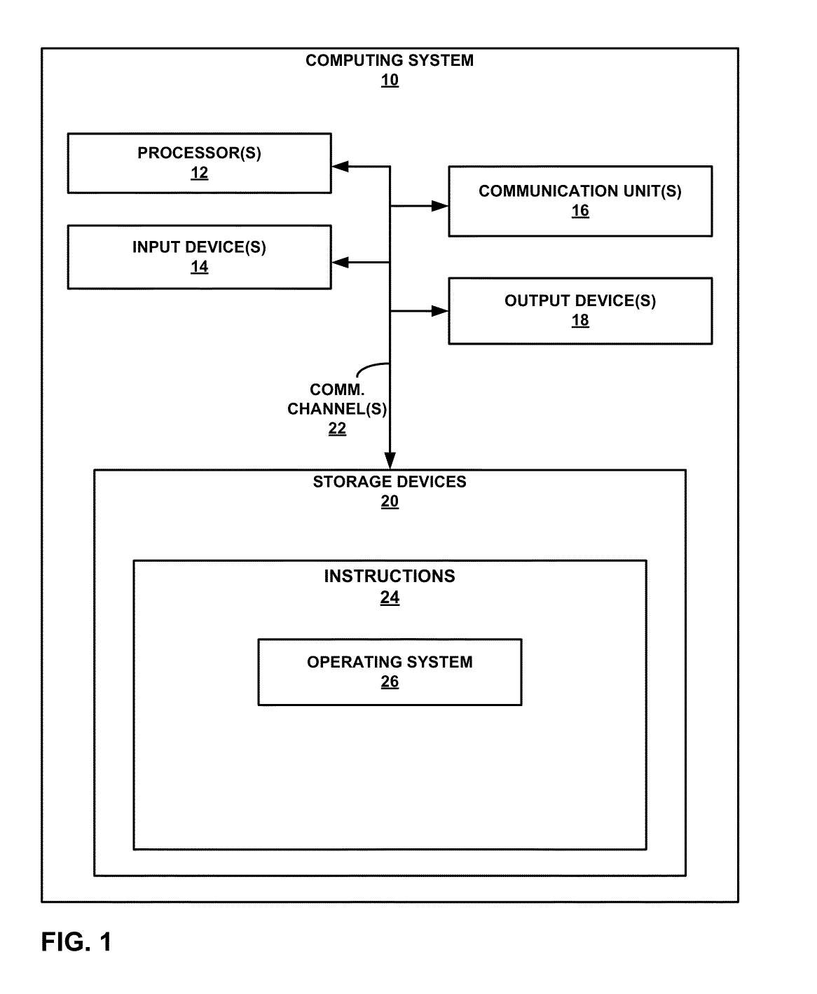

FIG. 1 is a block diagram that illustrates an example configuration of computing system 10, in accordance with one or more techniques of this disclosure as describe in further detail below with respect to the other figures of the disclosure. For purposes of illustration, FIG. 1 illustrates only one particular example of computing system 10, and many other example configurations of computing system 10 exist.

As shown in the example of FIG. 1, computing system 10 includes one or more processors 12, one or more input devices 14, one or more communication units 16, one or more output devices 18, one or more storage devices 20, and one or more communication channels 22. Computing system 10 may include many other components. For example, computing system 10 may include physical buttons, microphones, speakers, communication ports, and so on.

Communication channel(s) 22 interconnect each of the components 12, 14, 16, 18, and 20 for inter-component communications (physically, communicatively, and/or operatively). In some examples, communication channel(s) 22 include a system bus, a network connection, an inter-process communication data structure, or any other method for communicating data. In some examples, one or more of communication channel(s) 22 are implemented using a local area network (LAN) or a wide area network, such as the Internet.

Storage device(s) 20 within computing system 10 store information used during operation of computing system 10. In some examples, storage device(s) 22 have the primary purpose of being a short term and not a long-term computer-readable storage medium. In some such examples, storage device(s) 22 do not retain stored data if powered off. Examples of volatile memories include random access memories (RAM), dynamic random access memories (DRAM), static random access memories (SRAM), and other forms of volatile memories known in the art. In some examples, storage device(s) 22 are further configured for long-term storage of information as non-volatile memory and retain information after power on/off cycles. Examples of non-volatile memory configurations include magnetic hard discs, optical discs, floppy discs, flash memories, or forms of electrically programmable memories (EPROM) or electrically erasable and programmable (EEPROM) memories.

Computing system 10 is able to receive indications of user input from input device(s) 14. Examples of user input include tactile, audio, and video input. Example types of input device(s) 14 include presence-sensitive screens, touch-sensitive screens, mice, keyboards, voice responsive systems, video cameras, microphones, electronic pens, or other types of devices for detecting user input.

Communication unit(s) 16 may enable computing system 10 to send data on and receive data from a communications network, such as a local area network or the Internet. In some examples, communication unit(s) 16 include wireless transmitters and receivers that enable computing system 10 to communicate wirelessly with the communications network.

Output device(s) 18 generate output. Examples types of output include tactile, audio, and video output. Example types of output device(s) 18 include presence-sensitive screens, sound cards, video graphics adapter cards, speakers, cathode ray tube (CRT) monitors, liquid crystal displays (LCD), or other types of devices for generating output.

Storage device(s) 20 store data, such as computer-executable instructions 24. Processor(s) 12 read instructions 24 from storage device(s) 20 and execute instructions 24. Execution of instructions 24 by processor(s) 12 configure or cause computing system 10 to provide at least some of the functionality ascribed in this disclosure to computing system 10. As shown in the example of FIG. 1, instructions 24 include an operating system 26. Execution of instructions in operating system 26 causes computing system 10 to perform various functions to manage hardware resources of computing system 10 and to provide various common services for other computer programs. Execution of instructions stored in instructions 24 may also cause or configure computing system 10 to perform any of the behaviors of computing system 10 described below.

Computing system 10 may form a part (e.g., a payment processing arrangement) of a system, such as that of U.S. patent application Ser. No. 11/867,390, filed Oct. 4, 2007, or that of U.S. Pat. No. 5,910,896, filed Nov. 12, 1996, the entire content of both of which are hereby incorporated by reference.

### Indication of Buyer's Obligation to Pay Value Added Tax

Many countries require buyers of goods to pay a value added tax (VAT) on shipments of the goods. Because such shipments may cross international borders and because some shippers are responsible for paying the VAT, it may be difficult for a buyer to determine whether it is the buyer's responsibility to pay the VAT on the shipments. Payment of the VAT by the buyer may be referred to as reverse-charge VAT because it is a reverse of the typical pattern where a supplier pays the VAT.

In some examples, computing system 10 receives a configuration matrix from a buyer. The configuration matrix may include a plurality of rows and a plurality of columns. A first column of the configuration matrix corresponds to a country in which a carrier of a shipment is established. A carrier is an entity that is responsible for physically moving goods from one place to another. A second column of the configuration matrix corresponds to a country in which a recipient of a shipment is established. A third column of the configuration matrix corresponds to a country from which a shipment originates. A fourth column of the configuration matrix corresponds to a country that is the destination of a shipment. A fifth column of the configuration matrix indicates whether the carrier is responsible for paying the VAT on a shipment. A sixth column of the configuration matrix indicates whether the buyer is responsible for paying the VAT on the shipment. Each row of the configuration matrix corresponds to a different combination of a shipper, a carrier, an origination country, and a destination country. Computing system 10 may receive update (e.g., on a periodic basis) the configuration matrix from the buyer.

Further, computing system 10 receives one or more invoices for processing. The invoice may, for example, include shipment data for a shipment. In some examples, computing system 10 receives the shipment data from a computing system operated by the buyer. In other examples, computing system 10 receives the shipment data from a computing system operated by a carrier or by a shipper. Furthermore, in some examples, the invoice may be a consolidated invoice that includes invoices for multiple shipments.

The shipment data for a shipment may include information about a shipment of goods purchased by the buyer. For instance, the information in the shipment data may include an identifier of a carrier of the shipment, an identifier of a shipper of the shipment, an origin country of the shipment, and a destination country of the shipment.

In response to receiving the shipment data, computing system 10 may match the identifier of the carrier of the shipment, the identifier of the shipper of the shipment, the origin country of the shipment, and the destination country of the shipment to a row in the configuration matrix. For example, if the shipment data specified that X is the carrier of the shipment, that Y is the shipper of the shipment, that France is the origin country of the shipment, and that Germany is the destination country of the shipment, computing system 10 may identify a row in the configuration matrix that specifies X as the carrier, Y as the shipper, France as the origin country, and Germany as the destination country.

If the applicable row of the configuration matrix indicates that the buyer is responsible for paying VAT for the shipment, computing system 10 may determine, based on information in a stored profile for the buyer, the buyer's general ledger (GL) account codes for reverse charge VAT credits and reverse charge VAT debits.

Furthermore, if the applicable row of the configuration matrix indicates that the buyer is responsible for paying VAT for the shipment, computing system 10 may determine, based on information stored in the stored profile for the buyer, business rules for determining an amount of VAT owed by the buyer for the shipment. The buyer may provide to computing system 10 the business rules for determining that estimated amount of VAT owed by the buyer for the shipment.

In addition, if the applicable row of the configuration matrix indicates that the buyer is responsible for paying VAT for the shipment, computing system 10 may add two line items to the invoice. A first line item may specify a reverse charge VAT credit and the second line item may specify a reverse charge VAT debit. The reverse charge VAT credit line item may have a value equal to the amount of VAT owed by the buyer for the shipment. To ensure that the invoice actually indicates the amount of money owed by the buyer to the shipper, the reverse charge VAT debit line item may have a value equal to the negative of the amount of VAT owed by the buyer for the shipment. The VAT may be indicated at a consolidated invoice (header) level, an individual shipment level, a line item level, a combination of these levels. The reverse charge VAT line items may be referred to as Non-Financial Journal entries.

In this way, computing system 10 may receive an invoice that specifies a country in which a carrier of a shipment is established, a country in which a recipient of the shipment is established, an origin country of the shipment, and a destination country of the shipment. Computing system 10 may match, based on the country in which the carrier of the shipment is established, the country in which the recipient of the shipment is established, the origin country of the shipment, and the destination country of the shipment, the invoice to a row in a buyer-specified configuration matrix. In addition, computing system 10 may determine, based on the identified row in the buyer-specified configuration matrix, whether a buyer is responsible for payment of VAT on the shipment or whether the shipper is responsible for payment of the VAT on the shipment. In response to determining that the buyer is responsible for payment of the VAT on the shipment, computing system 10 may include a line item in the invoice that indicates that the buyer is responsible for payment of the VAT on the shipment. Computing system 10 may provide the invoice to the buyer.

In an alternate example, the first column of the configuration matrix may correspond to an identifier of a carrier and the second column may correspond to an identifier of a shipper. A shipper is an entity that ships goods to the buyer. A shipper may be a seller of the goods. Techniques similar to those described above may be applied in this example to match a row in the configuration matrix to an invoice.

Furthermore, computing system 10 may audit the invoice to determine whether the invoice complies with a contract. For example, computing system 10 may determine whether the invoice indicates that the amounts of products specified by the contract were shipped at the times specified by the contract. In another example, computing system 10 may determine whether a price specified by the invoice corresponds to a price specified by the contract. If the audit is successful, computer system 10 may process payment for the invoice. In some examples, computing system 10 may process payment of the VAT for the invoice. If the audit was not successful (e.g., there was an issue with the VAT), computer system 10 may route the invoice to an exception status. Furthermore, in some instances, computing system 10 may perform a VAT roll up audit and/or check for VAT roll up discrepancies and tolerances.

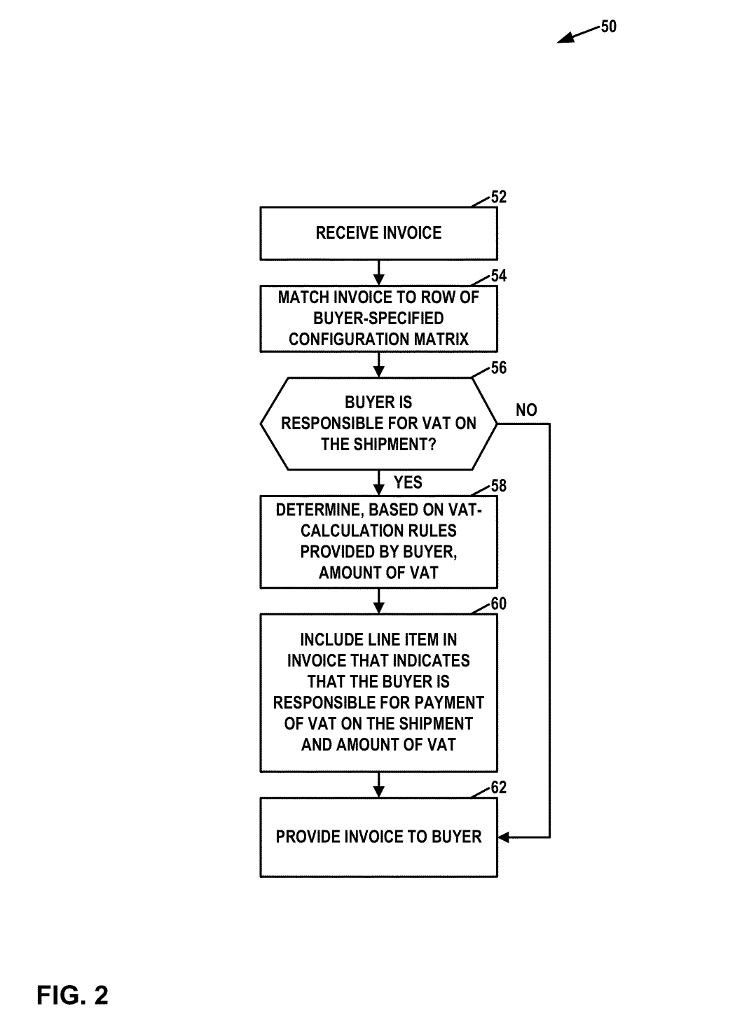

FIG. 2 is a flowchart that illustrates an example operation 200 for processing reverse-charge VAT. FIG. 2 is provided as an example. In other examples, operations for processing reverse-charge VAT may include more, fewer, or different steps.

In the example of FIG. 2, computing system 10 may receive an invoice that specifies a country in which a carrier of a shipment is established, a country in which a recipient of the shipment is established, an origin country of the shipment, and a destination country of the shipment (52). Computing system 10 may match, based on the country in which the carrier of the shipment is established, the country in which a recipient of the shipment is established, the origin country of the shipment, and the destination country of the shipment, the invoice to a row in a buyer-specified configuration matrix (54).

Computing system 10 may then determine, based on the identified row in the buyer-specified configuration matrix, whether a buyer is responsible for payment of VAT on the shipment (56). In response to determining that the buyer is responsible for payment of the VAT on the shipment (“YES” of 56), computing system 10 may determine, based on VAT-calculation rules provided by the buyer, an amount of the VAT on the shipment (58). In addition, computing system 10 may include a line item in the invoice that indicates that the buyer is responsible for payment of the VAT on the shipment and the amount of the VAT (60). After including the line item and amount of VAT in the invoice or in response to determining that the buyer is not responsible for the VAT on the shipment (“NO” of 56), computing system 10 may provide the invoice to the buyer (62).

The European value added tax (VAT) may appear at any level of an invoice document. Computer system 10 allows for the VAT to be presented at any document level: Consolidated invoice level, shipment header level (shipments comprise a consolidated invoice), shipment line level, any combination of the above.

The techniques of this disclosure may ensure that wherever the VAT appears, it rolls up precisely. For example, shipment level VATs should equal the total of all shipment line level VATs. Likewise, a consolidated invoice level VAT should equal the total of all shipment header level VATs.

VAT is a key component on EU invoicing and large fines may be leveled against Buyer and Supplier organizations if VAT is not calculated and paid correctly. The VAT solution of this disclosure may provide an automated means to assist in compliance with EU VAT directives.

The European Union value added tax (or EU VAT) is the consumption tax system common to nations in the EU VAT area. The EU itself does not collect the tax, but each EU member state is required to adopt a value-added tax that complies with the EU VAT system.

The EU VAT taxes the consumption of goods and services in the EU VAT area. The EU VAT system asks where the supply and consumption occurs, thereby determining which member state collects the VAT and what VAT rate is charged. The techniques of this disclosure may be applicable to VAT in jurisdictions other than the EU.

The general rule is that the VAT is collected where the goods are purchased by the consumer. The supply of goods (the exchange of goods for consideration) is a taxable transaction; that is, VAT at the appropriate rate is added to the purchase price.

Computer system 10 may perform a series of VAT audit checks on a consolidated invoice at the shipment line level, the shipment header level, and the consolidated invoice header level. If applicable, a General Ledger journal entry is created relative to the CI header VAT.

Further, end users may have the ability to either accept or deny shipments or consolidated invoices that are in an exception status due to the VAT not being present or the VAT not summing correctly between the consolidated invoice and shipment.

The VAT audit service may check whether the VAT should or should not be present on a shipment based on the origin, destination, buyer country, and supplier country information on a shipment.

The VAT audit service may review the roll-up of shipment line level VAT against the shipment header VAT and the consolidated invoice level VAT. In some examples, all must sum-up correctly.

Note: While the shipment and consolidated invoice levels are differentiated, the shipments determine whether VAT is required. Using the buyer's VAT matrix, this information is used to determine whether VAT is included on a consolidated invoice.

The VAT audit service may allow a non-financial journal entry to be added to the shipment to account for a reverse charge VAT (in the case where VAT should not be present on a shipment).

In some examples, payment can only be processed if all of the following VAT checks occur. If there are issues with any of these checks, then the consolidated invoice (or underlying shipments) must, in some examples, be corrected prior to payment being processed. Alternatively, the buyer can accept the differences, which may cause computing system 10 to auto-correct the transaction for the buyer; thus, the consolidated invoice is then paid.

At a high-level, the steps in the VAT service audit are split into the following phases:
1. Assign a non-financial journal entry (JE) to the appropriate shipment line items (must meet rule (a) and (b) to perform (c)).
   a. No VAT is present at the shipment level.
   b. Per the audit process, it is determined that no VAT is required.
   c. If (a) and (b) are met, then a secondary review is performed to determine whether or not a non-financial VAT journal entry is needed to account for a “reverse charge”. That is, the buyer remittance responsibility for the VAT is not paid to the supplier.
2. Check the total VAT amount on the consolidated invoice to ensure that the VAT line items sum-up correctly.
3. Evaluate the VAT at each level within the shipment to see if VAT is required or not.
   a. Check VAT at the shipment line level to see if required or not.
   b. If no VAT is included at the shipment line level, check VAT at the shipment level to see if required or not.
4. If the consolidated invoice or shipments fall into an exception status, allow buyers the ability to accept or deny transactions.

In step 3b, if no VAT is present at the shipment level and per the VAT presence audit process it is determined that no VAT is required, computer system 10 may perform a secondary review to check if a non-financial VAT journal entry is needed to account for reverse charge VAT (i.e., VAT that buyer is responsible for remitting as part of the invoice, however should not be paid to the supplier).

A non-financial journal entry can be added to a shipment for an estimated reverse charge VAT based on VAT rates provided by the customer. In order to accommodate customer requirements and not affect the settlement process, two accounting line items may be added to a shipment for a reverse charge VAT: one positive and one negative line item. A General Ledger (GL) Chart assignment policy rule is created to allow an accounting code assignment for the two reverse charge VAT line items.
a. The requirement for VAT to be included is determined by reviewing the shipment origin, destination, buyer country, and supplier country information.
b. A VAT matrix must be created by the buyer to accommodate the VAT Audit Process. According to the buyer's matrix, VAT audit only checks whether VAT should (or should not be) present on the consolidated invoice. This process does not validate whether the VAT amount is correct.

Since the shipment level includes the origin, destination, buyer country, and supplier country information, the shipments on a consolidated invoice determine whether the VAT is required. All shipments on the consolidated invoice need to be reviewed to determine if a non-financial journal entry needs to be generated (reverse charge VAT process).

Steps in the Process:
c. The VAT audit service reviews each shipment one-by-one within a consolidated invoice to see if VAT is required according to the matrix provided by the buyer.
d. If no VAT is required, a non-financial VAT journal entry is added based on buyer subscription to the service.
e. All transportation and service charge amounts (excluding all service charges with VAT amount) are added on the line items within a shipment to calculate a non-financial VAT journal entry, when necessary.

To illustrate the steps in the VAT audit process, a few scenarios are outlined below. Information from the Buyer-Provided Matrix example is used to demonstrate three shipping scenarios. Table 1, below, illustrates a buyer-provided configuration matrix.

TABLE 1

| | Carrier | Recipient | | | Invoice | VAT to |
|---|---|---|---|---|---|---|
| | established | established | Ship | | with | Self- |
| | in: | in: | from: | Ship to: | VAT? | invoice? |
| Shipment 1 | Italy | Germany | Romania | Czech | No | Yes |
| Shipment 2 | Italy | Germany | Italy | Italy | No | Yes |
| Shipment 3 | Germany | Germany | Germany | Germany | Yes | No |

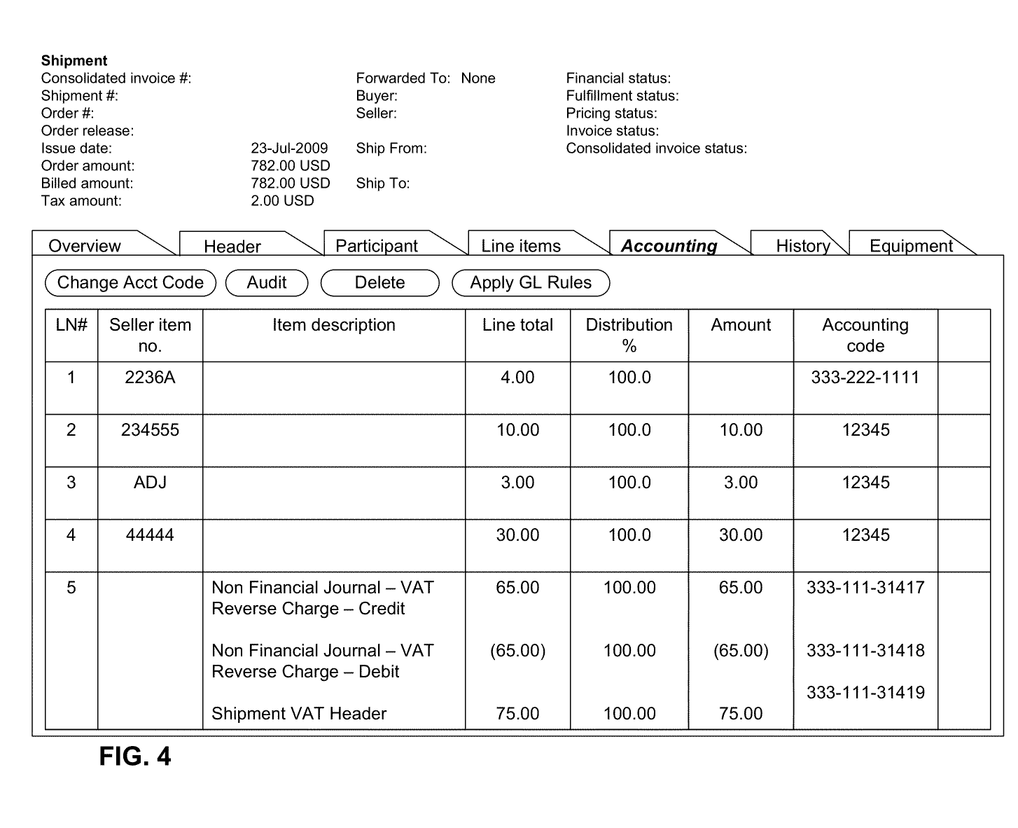

An invoice for Shipment 1 may include a transportation cost of 100 [symbol] , a service charge of 10 [symbol] , and VAT of 5 [symbol] . In this scenario, (according to the Buyer-Provided Matrix example), no VAT is required for Shipment 1. However, a VAT amount of 5 [symbol] is included in an invoice for shipment 1. In response to the invoice, computer system 10 may generate a non-financial journal entry by adding the Transportation and Service Charge amounts (100 [symbol] +10 [symbol] ) and then multiplying this amount by the buyer percentage. General Ledger (GL) account coding for the non-financial VAT entry is determined based on Chart of Account rules for the buyer. In the case where a non-financial VAT journal entry is needed, two non-financial line items are added to the shipment Accounting tab: one as a positive and one as a negative amount so the net effect of the journal entry is zero. Because, in this example, the VAT is wrongly included, the status for Shipment 1 may appear as VAT Audit Failed suspense status and, as a result, the whole consolidated invoice status appears as Incomplete. An example user interface showing “Non-Financial Journal-VAT” line items on the Accounting tab appears in the example of FIG. 4. FIG. 4 is a conceptual diagram that illustrates an example user interface showing “Non-Financial Journal-VAT” line items on an accounting tab.

An invoice for Shipment 2 may include a transportation cost of 150 [symbol] , a service charge of 15 [symbol] , and there may be no charged VAT. In this scenario (according to the Buyer-Provided Matrix example), no VAT is required and no VAT amount is included. Computing system 10 may generate a non-financial journal entry by adding the Transportation2 and Service Charge2 amounts (150 [symbol] +15 [symbol] ) and then multiplying this amount by the buyer percentage. Computer system 10 may determine General Ledger (GL) account coding for the non-financial VAT entry based on Chart of Account rules for buyer. In the case where a non-financial VAT journal entry is needed, computer system 10 adds two non-financial line items to the shipment Accounting tab . . . one as a positive and one as a negative amount so the net effect of the journal entry is zero.

An invoice for Shipment 3 may include a transportation charge may be 200 [symbol] , a service charge may be 20 [symbol] , and no VAT. In this scenario (according to the Buyer-Provided Matrix example), VAT is required. However, no VAT amount is included. Therefore, a non-financial journal entry should not be included. Because the shipment does not include VAT, the status for Shipment 3 may appear as VAT Audit Failed and, as a result, the whole consolidated invoice status may appear as Incomplete. Once a consolidated invoice passes the VAT Audit process, the consolidated invoice may appear in the Payment List with a review status of Audit Successful.

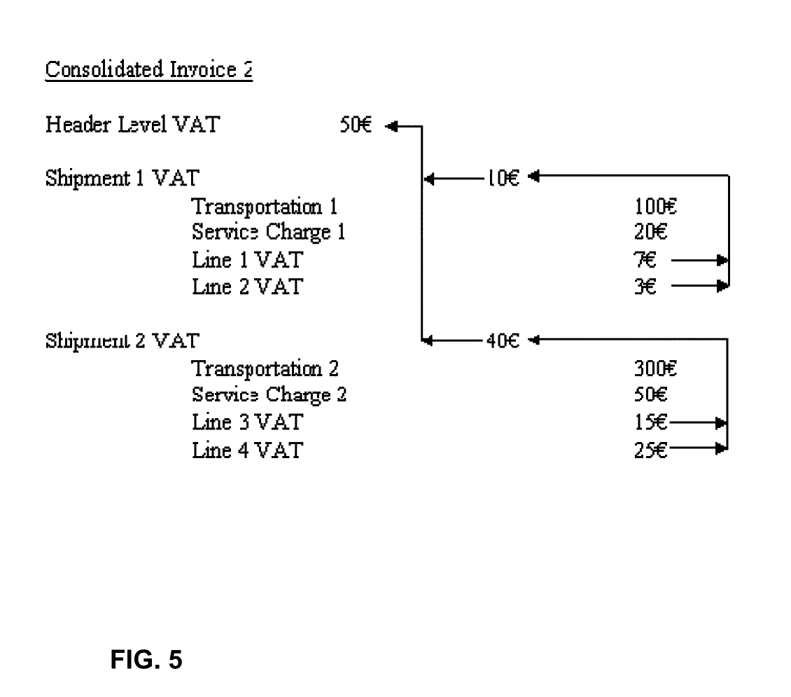

Computer system 10 may ensure that VAT line items sum correctly. FIG. 5 is a conceptual diagram that illustrates an example consolidated invoice. In the example of FIG. 5, Header Level VAT (50 [symbol] )—This amount should be a sum of “Shipment 1 VAT” (10 [symbol] ) and “Shipment 2 VAT” (40 [symbol] ). Shipment 1 VAT (10 [symbol] )—This amount should be a sum of “Line 1 VAT” (7 [symbol] ) and “Line 2 VAT” (3 [symbol] ). Shipment 2 VAT (40 [symbol] )—This amount should be a sum of “Line 3 VAT” (15 [symbol] ) and “Line 2 VAT” (25 [symbol] ).

If any of the VAT lines do not sum correctly, the whole consolidated invoice status may appear as Incomplete. Additionally, if the VAT lines within a shipment do not sum correctly, the shipment status may appear as Cross-level VAT Failed.

In the example of FIG. 5, VAT is only paid at the highest level, ensuring VAT is not double-paid. In the example above, only 50 [symbol] would be paid. General Ledger (GL) is only recorded at the lowest VAT line level. In the example above, the GL is recorded as follows:

| | |
|---|---|
| Line 1 VAT | 7 [symbol] |
| Line 2 VAT | 3 [symbol] |
| Line 3 VAT | 15 [symbol] |
| Line 4 VAT | 25 [symbol] |

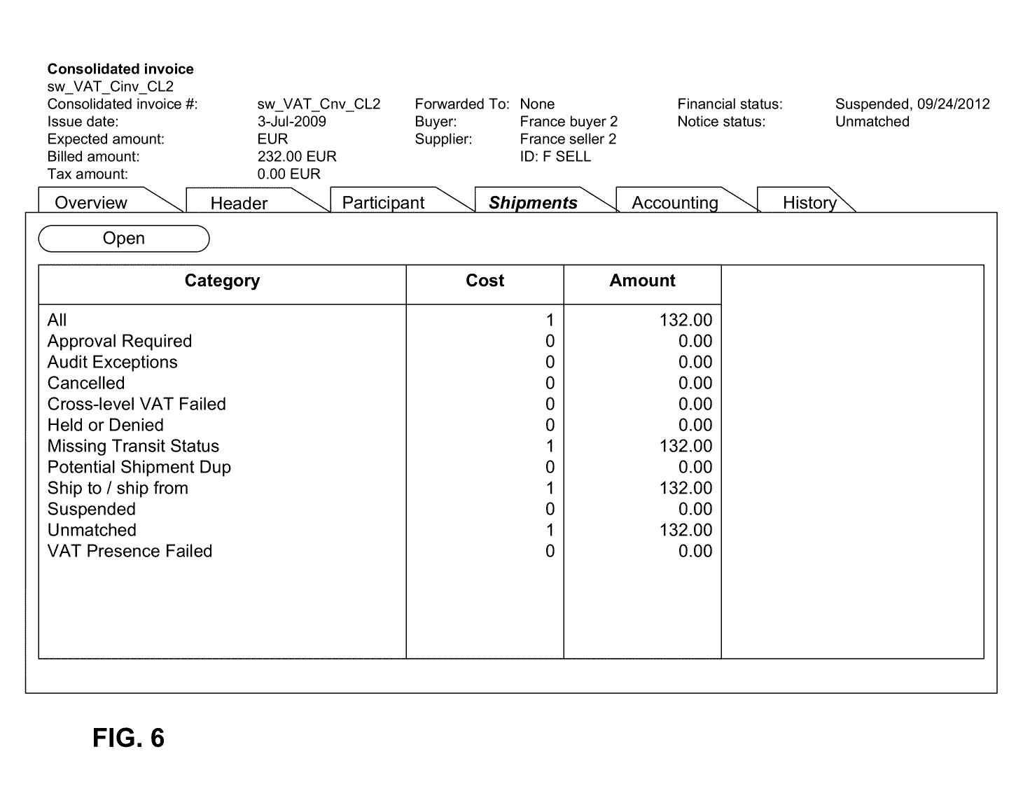

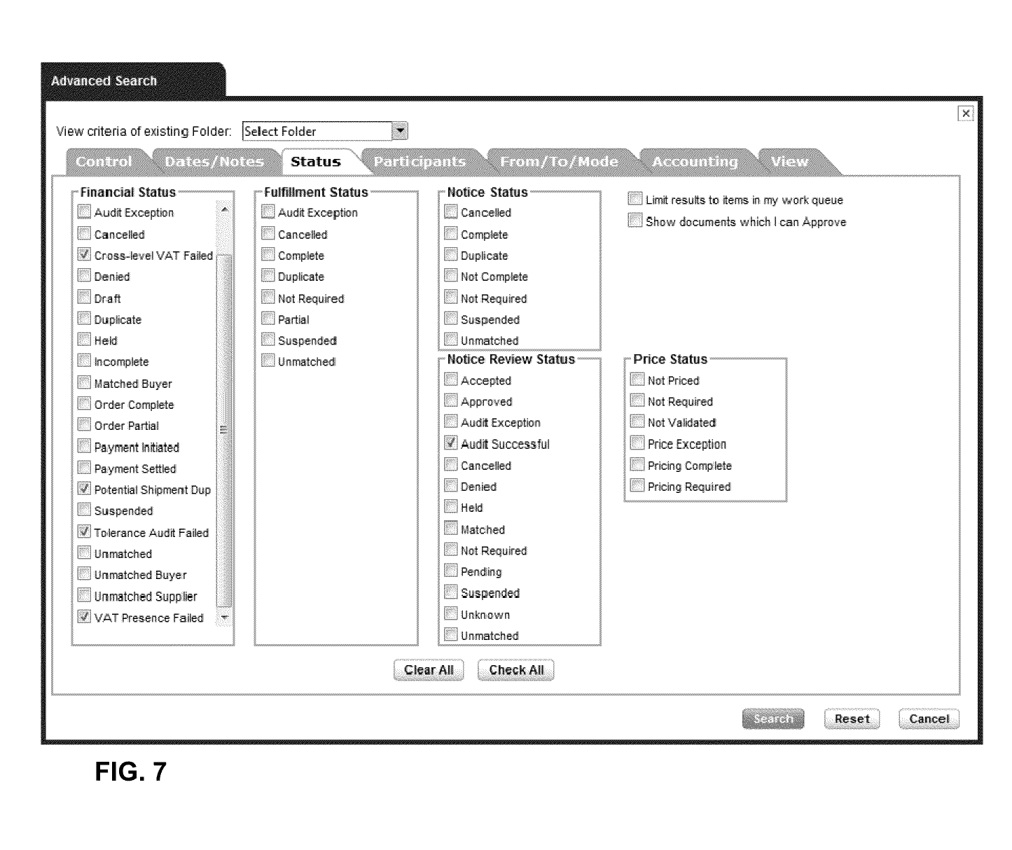

The VAT is not the only tax in EU (import duties, export duties, etc.). The system is not capable of checking for other taxes. The Shipments tab on the consolidated invoice may be clicked to view a list of financial statuses, for example, Cross-level VAT Failed, VAT Presence Failed, etc. This is shown in the example of FIG. 6. FIG. 6 is a conceptual diagram that illustrates an example shipments tab on the consolidated invoice. FIG. 7 is a conceptual diagram that illustrates example financial statuses available within a status tab of an advance search process. The financial statuses are also available within the Status tab of the ‘Advance Search’ process, as shown in the example of FIG. 7.

Computer system 10 may perform a VAT Audit Tolerance and Accounting Treatment. If VAT does not roll up to the expected amount, computer system 10 may apply a buyer-defined tolerance in order to prevent an exception from occurring in cases of a VAT rounding issues. If the difference amount is within tolerance, computer system 10 may add a financial journal entry at the header or shipment level to account for the difference. If the difference amount is out of tolerance, the shipment and consolidated invoice transaction go into audit exception to be resolved by the user.

### Conversion of Monetary Values to a Reference Currency

A business entity may generate and/or receive documents that include monetary values in various currencies. For example, a business entity may generate and/or receive invoices, orders, bills of lading, tax documents, and other types of documents that include monetary values. Because such documents include monetary values in various currencies, the business entity may be unable to determine, in the absolute terms of a single currency, how much money the business entity is spending and how much money the business entity is receiving.

In this example, computing system 10 receives a set of business rules for a business entity. The business rules for the business entity may specify a reference currency. For example, the business rules for the business entity may specify United States dollars as the reference currency. In some examples, a business entity may specify only a single reference currency.

In addition, the business rules for the business entity may specify one or more sources of currency conversion rates. In some instances, the sources of currency conversion rates may be public sources of currency conversion rates, such as the Wall Street Journal, or another source of publicly-available currency conversion rates. In other instances, the sources of currency conversion rates may be private sources of currency conversion rates. Such private sources of currency conversion rates may include business rules that explicitly specify currency conversion rates. The use of private sources of currency conversion rates may help with internal reporting requirements of divisions of the business entity, may reduce the effects of sudden shifts in currency conversion rates, and/or may provide other benefits that particular business entities may find desirable. In some examples, the business rules for the business entity may provide for different sources of currency conversion rates for different types of transactions or business purposes.

Furthermore, the business entity's business rules may specify times at which computing system 10 is to retrieve currency conversion rates from the source of currency conversion rates. For example, the business entity's business rules may specify that computing system 10 is to retrieve currency conversion rates weekly on Tuesdays.

In addition, computing system 10 may receive contract data. The contract data may specify terms of contracts between the business entity and other business entities. The terms of a contract may include a price that the business entity is to pay or is to be paid in relation to a transaction associated with the contract.

Furthermore, computing system 10 may receive a document, such as an invoice, associated with a transaction. In response, computing system 10 may identify a contract associated with the transaction. The document may include one or more monetary values.

In response to receiving the document, computing system 10 may determine, from the contract terms of the identified contract, an expected monetary amount that the business entity is to pay or is to be paid in relation to the transaction. Computing system 10 may then use a currency conversion rate to convert this expected monetary amount into a currency of the monetary amounts specified in the document. Computing system 10 may determine the currency conversion rate based on data from the source of currency conversion rates specified by the business rules for the business entity. In some examples, computing system 10 may use an electronic communications interface, such as a web services interface to retrieve the currency conversion rate from the source of currency conversion rates.

Computing system 10 may then compare the converted expected monetary amount to a monetary amount specified in the document. If the converted expected monetary amount corresponds to (e.g., is greater than or equal to) the monetary amount specified in the document, computing system 10 may generate electronic settlement data to effect a payment for the transaction to or from the business entity.

Furthermore, computing system 10 may convert monetary amounts in the received document to the reference currency for the business entity. Computing system 10 may use a currency conversion rate from a source of currency conversion rates specified by the business rules of the business entity. For example, if the document specifies a monetary amount in Yen and the business entity's reference currency is United States dollars, computing system 10 may convert the monetary amount to United States dollars.

After converting the monetary amount into the business entity's reference currency, computing system 10 may store the converted monetary amount into a database. The database may store monetary amounts from various types of documents received and/or generated by the business entity. Each of these monetary amounts may be in the business entity's reference currency.

A business intelligence engine running on computing system 10 or another computing system may query the database to extract various types of business intelligence information. Such business intelligence information may include information regarding the business entity's global spending and revenue patterns. Buyers may choose to see business intelligence reports in the reference currency and/or the original currencies. In some examples, computing system 10 may convert monetary amounts from their original currencies to the reference currency when computer system 10 receives a request for a business intelligence report.

In some examples, an account can only support transactions in one currency. An account may also have a specific credit limit assigned to it if there is a desire to limit the credit for a particular buyer site. This account limit is still part of the account associated with the overall facility. The determination of how many credit facilities are required by a buyer may be based on the following factors. First, how a sponsor might want to split the credit between buyer sites to facilitate the proper usage of credit between buyer sites. Second, how many different currencies are in use by the buyer? Third, are credit limits set up at the account level? A credit facility can be set up for each currency, or currencies (i.e., accounts with different currencies) can be mixed in a single facility. Computer system 10 may use an “indicative currency exchange rate” that can be set to “approximate” the impact to the facility if multiple currencies are mixed in a facility. This may be important to understand because when each transaction is authorized, the currency conversion may be done using the conversion factor set up in computing system 10. The conversion factor may be an approximation of real time currency exchange rates.

Computing system 10 may process and pay invoices in multiple currencies. The Exchange Rate Service may provide information necessary to convert disparate currencies to a single common currency. There may be three basic business benefits that derive from the ability of computing system 10 to perform currency conversions. The techniques of this disclosure for currency conversion may address the following three items. First, provide participants the ability to perform price audits in cases where an invoice is presented in a currency other than the rating contract between buyer and supplier. Second, normalizing managerial reporting across currencies for organization branch, participant, sponsor (and any sponsor branches) and a network. Third, normalizing data analysis for organization branch, participant, sponsor (and any sponsor branches) and a network.

TABLE 2

| Business Issue | Feature | Improvement | Benefit |
|---|---|---|---|
| Trade Document | Contract pricing | The line items | No processing |
| Currency type differs | results are converted | submitted in a trade | interruptions due to a |
| from contract | to match the trade | document no longer | currency mismatch. |
| currency type (e.g., | document for | have to be in the | |
| transportation | comparison | same currency as the | |
| contract currency | | contract. Pricing | |
| type) | | results are now | |
| | | calculated and | |
| | | converted to the trade | |
| | | document currency type | |
| Normalize two or | Line items are | Pricing was unable to | Now a trade |
| more items within a | converted (if | price in this situation | document can be |
| contract that have | necessary) to the | | submitted when the |
| been set up in more | currency type | | contract items being |
| than one currency | contained on the | | priced are in multiple |
| | submitted trade | | currencies |
| | document | | |
| Need the ability to | Currency Profile is | A profile for an | Flexibility in |
| assign exchange rate | set up for an | organization can be | determining |
| characteristics to a | organization | established which | exchange rate |
| specific organization | containing rate | determines exchange | sources and the |
| | source and update | rate source to be used | ability to use |
| | frequency | (public or private) | privately developed |
| | | and frequency of | exchange rates for |
| | | update. | conversion. |
| Reporting for an | A reference currency | Monetary | Data and financial |
| organization needs to | is assigned to an | information is now | analysis is easier to |
| be normalized to a | organization and | normalized through a | perform. |
| common currency | linked to exchange | single currency. | |
| | rate tables | | |

A currency service of computing system 10 may return an exchange rate to a calling service based on criteria sent in a request message to the service. The currency service may receive requests from calling applications and, based on the rules outlined in the source configuration/currency profile definitions, returns an exchange rate to the calling application. If the service fails to find an exact date match, the service may looks for a best match. If the service fails to find an exact currency pair match, the service may look to the default. If the currency service fails to find an exchange rate that matches the criteria, the service may generate an error message that the service may pass back to the calling application.

Access to view and edit exchange rate information may be achieved through a source configuration manager. Source configuration may be used to define how exchange rate tables in the database are populated. The source configuration manager may also provide a way to control exchange rate content and frequency of updates as well as usage of exchange rate information.

There are two roles defined that determine the level of user access to the source configuration user interface: Exchange Rate Administrator—a network user who is authorized to view and perform all functions related to creating and maintaining exchange rate sources and exchange rates across companies. Exchange Rate Auditor—a network, sponsor or participant user who is authorized to view exchange rate sources and exchange rates. Companies that utilize the Exchange Rate Service may have a currency profile associated to them. The company may then be able to take advantage of all the parameters of a source configuration.

Reference currency codes may be assigned as a default company-level reference currency or to lower level organizations.
Customer ID—identifies the company to which the profile applies.
Organization ID—identifies the organization to which the reference currency is assigned. The reference currency applies to all organizations at and below the designated organization unless a different source is assigned to a lower level organization. In other words, given an organization, the first reference currency found at or above it, applies.
Business Purpose—identifies the business area or application that uses the reference currency, for example, pricing or business intelligence.
Effective Date/Time—identifies the date the reference currency becomes effective. Companies/organizations may have more than one reference currency assigned to a business segment for different date spans.
Expiration Date/Time—identifies the last date that the reference currency is used (may be evergreen).
Last Update User—for audit purposes.
Last Update Date/Time—for audit purposes.

The company may assign exchange rate sources at the company or at lower organization levels for different business segments as reflected in the currency profile source entity.
Customer ID—identifies the company to which the profile applies.
Organization ID—identifies the organization to which the source is assigned. The source applies to all organizations at and below the designated organization unless a different source is assigned to a lower level organization. In other words, given an organization, the first source found at or above it, applies.
Business Purpose—identifies the business area or application that uses the source, for example, pricing or business intelligence.
Spend Category—identifies the industry that uses the source, for example, transportation or utilities.
Trading Partner Organization ID—the source may optionally apply to a specific trading partner organization.
Exchange Rate Source Name—identifies the source assigned to an organization/business segment.
Rate Type—identifies the rate type to be used for the given source (ask, bid, midpoint, custom).
Effective Date/Time—identifies the date the source becomes effective. Companies/organizations may have more than one source assigned to a business segment for different date spans.

The following attributes may be defined for each source assigned to an organization:
Search Type—defines the following search parameters for exchange rates:
   Date or Time—whether the service should find rates based only on date or if the rate search is time sensitive (future development).
   Best or Exact Match—whether the service should look only for an exact match on date/time or the most current rate failing an exact match.
Calculate Rate—whether the service should calculate a rate based on the exchange rate basis currency code if a direct rate is not found (yes/no).
Exchange Rate Base Currency Code—currency to use for rate calculation if calculate rate=“yes” and a direct rate for the requested currencies is not found.
Expiration Date/Time—identifies the last date that the source is used (may be evergreen).
Last Update User—for audit purposes.
Last Update Date/Time—for audit purposes.

This section describes the rate retrieval process using pricing as an example.

The pricing engine may receive a price request message with requested currency and a rate basis date. Upon receipt of the request, the pricing service may call an exchange rate service to retrieve an exchange rate if contract prices are in a different currency than the requested currency in the price request.

The pricing service may retrieve the source name, rate type, exchange rate base currency code, and search type from the currency profile for the given buyer and supplier organizations to populate the exchange rate request.

The currency service may receive a request from the calling service and searches for an exchange rate based upon the search type criteria (exact or best match). In some examples, if “exact match” is specified, the service must have an exchange rate for a currency pair within in its table that matches the requestor date exactly. If the search type is “best match”, the service may look for a matching date. If the service cannot find an “exact match” however, the service may look back in time to find the most recent date with a matching currency pair and returns that pair's rate.

There may also be a feature in the currency service that utilizes a “base currency.” If a requested currency pair is not found in the service, a base currency feature may be turned on for a customer. A base currency may be used as a currency translator. An example of this process is if New Taiwan Dollar (TWD) to Japanese Yen (JPY) is requested and that direct currency pair is not found in the currency service. The company may have specified USD as a base currency. If that is the case, TWD is converted to USD. Then the USD amount is converted to JPY resulting in an indirect exchange rate for TWD to JPY.

Another feature in the currency service may be the ability to return exchange rates based upon a business purpose. If a company wishes to use one exchange rate source for Business Intelligence reporting and another source for pricing, they have the ability to designate the source to use with a particular business purpose.

Once the pricing service has sent an exchange rate request and received an exchange rate response (using the previously explained selection criteria), the pricing engine may be responsible for calculating prices in the price request currency (requested currency) using the exchange rate returned by the service. The rate returned is a “multiply by” rate.

The pricing service may then return conversion information in the price response to the calling service after the rating and conversion has been performed.

### Resolution of Geographic Identifiers

Computing system 10 may process supply-chain transactions and may receive documents that include wide variations in the identifiers used to identify geographic locations. For example, computing system 10 may receive a first document and a second document. In this example, the first document may use “St. Paul, Minn.” to identify the city of “Saint Paul, Minn.” while the second document uses “ST PAUL, MN” to identify the city of “Saint Paul, Minn.” In another example, some documents may use a zip code or other postal code to refer to a specific city without specifying the actual name of the city. Furthermore, documents in different languages may use different words for the same place (e.g., “Nice” in French vs. “Nizza” in Italian). may use a name of a place

Such computing systems may treat each variation of a geographic identifier as an identifier of a different geographic location. This may lead to processing errors or the generation of incorrect data.

In accordance with the techniques of this disclosure, computing system 10 stores an alias database. The alias database includes data to map known variations of geographical identifiers to normalized geographical identifiers. For example, the alias database may include data that map the geographical identifiers “St. Paul, Minn.” and “ST PAUL, MN” to “Saint Paul, Minn.”

Furthermore, computing system 10 may receive a document, such as an invoice, a bill of lading, or contract document. In response to receiving the document, computing system 10 may provide the document to a geographic resolution service. The geographic resolution service may use the alias database to return normalized versions of geographic identifiers in the document and the original versions of geographic identifier in the document.

Subsequently, computing system 10 may output the document to another user. When computing system 10 outputs the document, the document may include the original version of the geographic identifier. This may help to ensure that the document has the geographic identifier that an end-user expects to see on the document.

Computing system 10 may use various rules to determine how to convert a geographic identifier into a normalized geographic identifier. For example, computing system 10 may use a set of regular expressions to convert geographic identifiers into normalized geographic identifiers.

In another example, computing system 10 may include a hierarchy of rules. This hierarchy of rules may control how computing system 10 converts received geographic identifiers to normalized geographic identifiers. For instance, a received geographic identifier may include conflicting information. An example of conflicting information may be a geographical identifier that specifies a city and a postal code that does not correspond to the city. When a received geographic identifier includes conflicting information, computing system 10 may use the hierarchy of rules to determine which piece of information takes priority. For instance, computing system 10 may determine that postal codes take priority over city names.

### “Milk Runs”

In some instances, a business entity has facilities in different countries. For example, the business entity may have a facility in France, a facility in Germany, and a facility in Italy. The facilities may be locations associated with national facilities of the business entity. The business entity may order a supply of goods from a supplier. For example, the business entity may order 1000 kg of a particular chemical. Parts of this supply are to be delivered to different facilities of the business entity in accordance with a previously-determined contract with a carrier. In response to the order, the supplier may provide the supply of goods to the carrier. The carrier may deliver the goods to the facilities according to a path defined by the previously-determined contract. Because the carrier delivers the goods according to a previously-determined path, the delivery transaction may be referred to as a milk run transaction. For example, the carrier may first deliver a portion of the ordered goods to the business entity's French facility, then deliver another portion of the ordered goods to the business entity's German facility, and then finally deliver a portion of the ordered goods to the business entity's Italian facility.

The carrier may send invoices to each of the facilities. For example, if the carrier delivered goods to the business entity's France, Germany, and Italy facilities, the carrier sends invoices to the business entity's France, Germany, and Italy facilities.

In accordance with the techniques of this disclosure, computing system 10 may receive the order from the business entity and may receive the invoices for the facilities. In some examples, computing system 10 may receive the invoices from the facilities. In other examples, computing system 10 may receive the invoices from the carrier. Computing system 10 may determine whether invoices have been received for each facility. If computing system 10 has received invoices to each of the facilities, computing system 10 may initiate payment for the invoices. In this way, computing system 10 does not initiate payment for any invoice associated with an order until computing system 10 has received each other invoice associated with the order.

Furthermore, each of the invoices associated with an order may specify quantities of products delivered to each of the facilities. If the total of the quantities specified by the invoices does not match the quantity specified by the order, computing system 10 may not initiate payment for any of the invoices. For example, a first, second and third invoice may be associated with an order. In this example, the first invoice may specify that 600 kg of a product were delivered to the French facility, 400 kg of the product were delivered to the German facility, and that 1000 kg of the product were delivered to the Italian facility. If the order was for 2500 kg of the product, computing system 10 may determine that some of the order has not been delivered and may not initiate payment for the first, second, or third invoices. On the other hand, if the order was for 2000 kg of the product, computing system 10 may initiate payment for the first, second, and third invoices.

In this way, computing system 10 may receive an order from a buyer. The order may specify quantities of goods to be shipped, by a shipper and accordingly to a predefined route, from a shipper to a plurality of facilities associated with the buyer. In addition, computing system 10 may receive a plurality of invoices to the facilities. In response to determining that the invoices include invoices to each of the facilities, computing system 10 may initiate an electronic payment for the goods. Furthermore, computing system 10 may determine whether the invoices to each of the facilities specify quantities that sum to a quantity of goods specified by the order. Computing system 10 may initiate the electronic payment for the goods in response to determining that the invoices to each of the facilities specify quantities that sum to the quantity of goods specified by the order.

The mechanism for checking whether each of the invoices associated with an order and the mechanism for determining that the ordered quantity of goods has been delivered may be implemented in various ways. For example, computing system 10 may store a profile for the business entity and separate profiles for each facility of the business entity. In this example, computing system 10 may receive an order from the business entity and modify the business entity's profile to record the order. In addition, computing system 10 may automatically modify the facilities' business profiles to record the order. Subsequently, computing system 10 may receive the invoices. In response to receiving an invoice for a facility, computing system 10 may provide the invoice to the facility for approval. In addition, computing system 10 or the facility may determine whether the quantity of goods delivered to the facility is less than a total quantity indicated by the order. If so, computing system 10 may indicate approval of the invoice. After a facility approves an invoice, computing system 10 may determine whether each of the invoices for the order has been approved. If so, computing system 10 may determine whether the total quantity of goods delivered matches the quantity of goods ordered. If so, computing system 10 may initiate payments of the invoices.

In another example, computing system 10 may enable the facilities to review the invoices received by their peer facilities. For example, the German facility may be able to review the invoices received by the French facility, and vice versa. When computing system 10 receives an invoice for a facility, the facility (or computing system 10) may determine whether the quantity of good delivered to the facility and the quantity of goods delivered to other facilities matches the quantity of goods ordered. If so, the facility may approve the invoice. Once each of the facilities have approved the invoices associated with the order, computing system 10 may initiate payment for each of the invoices.

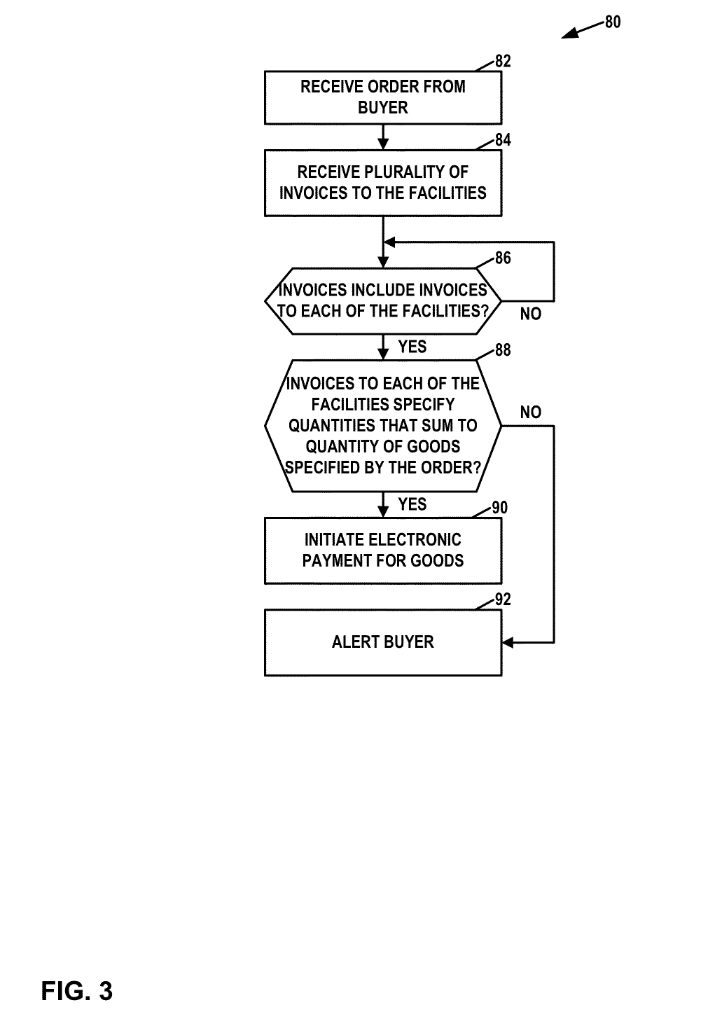

FIG. 3 is a flowchart that illustrates an example operation 80 for processing a milk run transaction. FIG. 3 is provided as an example. In other examples, operations for processing milk run transactions may include more, fewer, or different steps.

In the example of FIG. 3, computing system 10 may receive an order from a buyer (82). The order may specify quantities of goods to be shipped, by a shipper and accordingly to a predefined route, from a shipper to a plurality of facilities associated with the buyer. In addition, computing system 10 may receive a plurality of invoices (84). Computing system 10 may determine whether the received invoices include each of the invoices to the facilities associated with the order (86). If the received invoices do not include each of the invoices to the facilities associated with the order (“NO” of 86), computing system 10 may wait until computing system 10 does receive each of the invoices to the facilities associated with the order.

In response to determining that the invoices include invoices to each of the facilities associated with the order (“YES” of 86), computing system 10 may determine whether the invoices to each of the facilities specify quantities that sum to a quantity of goods specified by the order initiating, by the computing system, an electronic payment for the goods (88). In response to determining that the invoices include invoices to each of the facilities associated with the order and in response to determining that the invoices to each of the facilities specify quantities that sum to the quantity of goods specified by the order (“YES” of 88), computing system 10 may initiate electronic payment for the goods (90). Otherwise if the invoices to each of the facilities do not specify quantities that sum to a quantity of goods specified by the order (“NO” of 88), computing system 10 may alert the buyer (92).

At least some examples provided in this disclosure may be used in conjunction with one another. For example, a single system may implement the currency conversion techniques, the geographical resolution techniques, the milk run techniques, and other techniques described in this disclosure.

Example 1, a method comprising: receiving, by a computing system, an order from a buyer, the order specifying quantities of goods to be shipped, by a shipper and accordingly to a predefined route, from a shipper to a plurality of facilities associated with the buyer; receiving, by the computing system, a plurality of invoices; and in response to determining that the invoices include invoices to each of the facilities, initiating, by the computing system, an electronic payment for the goods.

### Example 2

The method of example 1, wherein the method further comprises determining whether the invoices to each of the facilities specify quantities that sum to a quantity of goods specified by the order; and wherein initiating the electronic payment comprises initiating, by the computing system, the electronic payment for the goods in response to determining that the invoices to each of the facilities specify quantities that sum to the quantity of goods specified by the order.

### Example 3

A computing device that comprises one or more processors configured to: receive an order from a buyer, the order specifying quantities of goods to be shipped, by a shipper and accordingly to a predefined route, from a shipper to a plurality of facilities associated with the buyer; receive a plurality of invoices; and in response to determining that the invoices include invoices to each of the facilities, initiate an electronic payment for the goods.

### Example 4

The computing device of example 3, wherein the one or more processors are further configured to determine whether the invoices to each of the facilities specify quantities that sum to a quantity of goods specified by the order; and wherein the one or more processors are configured to initiate the electronic payment for the goods in response to determining that the invoices to each of the facilities specify quantities that sum to the quantity of goods specified by the order.

### Example 5

A computer-readable storage medium that stores instructions that, when executed by one or more processors of a computing system, cause the computing system to: receive an order from a buyer, the order specifying quantities of goods to be shipped, by a shipper and accordingly to a predefined route, from a shipper to a plurality of facilities associated with the buyer; receive a plurality of invoices; and in response to determining that the invoices include invoices to each of the facilities, initiate an electronic payment for the goods.

### Example 6

The computer-readable storage medium of example 5, wherein the instructions, when executed by the one or more processors, cause the computing system to determine whether the invoices to each of the facilities specify quantities that sum to a quantity of goods specified by the order; and wherein the instructions, when executed by the one or more processors, cause the computing system to initiate the electronic payment for the goods in response to determining that the invoices to each of the facilities specify quantities that sum to the quantity of goods specified by the order.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
receiving, by a computing system, an invoice that specifies a country in which a carrier of a shipment is established, a country in which a recipient of the shipment is established, an origin country of the shipment, and a destination country of the shipment;
matching, by the computing system and based on the country in which the carrier of the shipment is established, the country in which the recipient of the shipment is established, the origin country of the shipment, and the destination country of the shipment, the invoice to a row in a buyer-specified configuration matrix;
determining, by the computing system and based on the identified row in the buyer-specified configuration matrix, whether a buyer is responsible for payment of value-added tax (VAT) on the shipment or whether the shipper is responsible for payment of the VAT on the shipment;
in response to determining that the buyer is responsible for payment of the VAT on the shipment, including, by the computing system, a line item in the invoice that indicates that the buyer is responsible for payment of the VAT on the shipment; and
providing, by the computing system, the invoice to the buyer.

2. The method of claim 1, further comprising:
determining, by the computing system and based on VAT-calculation rules provided by the buyer, an amount of the VAT on the shipment; and
indicating, by the computing system and on the invoice, the amount of the VAT on the shipment.

3. A computing device that comprises one or more processors configured to:
receive an invoice that specifies a country in which a carrier of a shipment is established, a country in which a recipient of the shipment is established, an origin country of the shipment, and a destination country of the shipment;
match based on the country in which the carrier of the shipment is established, the country in which the recipient of the shipment is established, the origin country of the shipment, and the destination country of the shipment, the invoice to a row in a buyer-specified configuration matrix;
determine, based on the identified row in the buyer-specified configuration matrix, whether a buyer is responsible for payment of value-added tax (VAT) on the shipment or whether the shipper is responsible for payment of the VAT on the shipment;
in response to determining that the buyer is responsible for payment of the VAT on the shipment, include a line item in the invoice that indicates that the buyer is responsible for payment of the VAT on the shipment; and
provide the invoice to the buyer.

4. The computing device of claim 3, wherein the one or more processors are configured to:
determine, based on VAT-calculation rules provided by the buyer, an amount of the VAT on the shipment; and
indicate, on the invoice, the amount of the VAT on the shipment.

5. A computer-readable storage medium that stores instructions that, when executed by one or more processors of a computing system, cause the computing system to:
receive an invoice that specifies a country in which a carrier of a shipment is established, a country in which a recipient of the shipment is established, an origin country of the shipment, and a destination country of the shipment;
match based on the country in which the carrier of the shipment is established, the country in which the recipient of the shipment is established, the origin country of the shipment, and the destination country of the shipment, the invoice to a row in a buyer-specified configuration matrix;
determine, based on the identified row in the buyer-specified configuration matrix, whether a buyer is responsible for payment of value-added tax (VAT) on the shipment or whether the shipper is responsible for payment of the VAT on the shipment;
in response to determining that the buyer is responsible for payment of the VAT on the shipment, include a line item in the invoice that indicates that the buyer is responsible for payment of the VAT on the shipment; and
provide the invoice to the buyer.

6. The computer-readable storage medium of claim 5, wherein the instructions, when executed by the one or more processors of the computing system, cause the computing system to:
determine, based on VAT-calculation rules provided by the buyer, an amount of the VAT on the shipment; and
indicate, on the invoice, the amount of the VAT on the shipment.
